(19) United States
(12) Patent Application Publication
(10) Pub. No.: US 2026/0198708 A1
(43) Pub. Date: Jul. 16, 2026

(54) SHOWCASE HAVING SILDING DOOR WITH STOP STRUCTURE

(71) Applicant: BLUENIX Co., Ltd., Ansan-si (KR)

(72) Inventor: Seok Hun KIM, Bucheon-si (KR)

(73) Assignee: BLUENIX Co., Ltd., Ansan-si (KR)

(21) Appl. No.: 19/221,456

(22) Filed: May 28, 2025

(30) Foreign Application Priority Data
Jan. 15, 2025 (KR) 10-2025-0005812

(51) Int. Cl. A47F 3/04; E05D 15/06

(52) U.S. Cl. CPC A47F 3/043; E05D 15/0665; A47F 3/0434

(57) ABSTRACT

Provided is a refrigerating showcase having a sliding door with a stop structure, wherein a plurality of sliding doors are supported in a first direction on a slide groove of a door frame, a gasket is installed on one surface of each sliding door in a third direction, and is in close contact with an adjacent sliding door to prevent leakage of internal cold air, a rail formed to be inclined to one side is installed on at least one of upper or lower slide groove of the door frame, the rail being installed so that one of rollers is positioned on the rail when the sliding door is closed, and although gaskets are caught with each other when the adjacent sliding door is opened, the sliding door having the roller positioned on the rail is prevented from being opened by elasticity of the rail.

### CROSS-REFERENCE TO RELATED APPLICATION(S)

This application claims benefit of priority to Korean Patent Application No. 10-2025-0005812 filed on Jan. 15, 2025 in the Korean Intellectual Property Office, the disclosure of which is incorporated herein by reference in its entirety.

### BACKGROUND

### 1. Field

The present disclosure relates to a showcase having a sliding door with a stop structure.

### 2. Description of Related Art

A showcase is a display case that displays and refrigerates food products that require storage at low temperatures in stores or large supermarkets. Differences from general refrigerators are that showcases have a transparent door so that the food products inside may be visually checked from the outside and have a structure extending horizontally and having a plurality of sliding doors so that a large number of food products may be stored and easily removed therefrom.

A gasket is installed between the sliding doors in such a showcase to prevent leakage of internal cold air.

However, a showcase equipped with a gasket may have a problem in that, when the sliding door is opened, adjacent gaskets are pushed against each other and another sliding door adjacent to the sliding door opened by the user may be unexpectedly opened, thereby consuming a lot of energy.

For example, in a showcase including three sliding doors, when a left sliding door is pushed to the right to open, a central sliding door may also open to the right due to a central cold air leakage prevention gasket.

### SUMMARY

An aspect of the present disclosure is to provide a showcase having a sliding door with a stop structure, capable of preventing, when a sliding door is opened, an adjacent sliding door from opening unexpectedly.

The problem of the present disclosure is not limited to the aforementioned contents. Those skilled in the art to which the present disclosure pertains will have no difficulty in understanding additional problems of the present disclosure from the overall contents of this specification.

According to an aspect of the present disclosure, there is provided a refrigerating showcase having a sliding door with a stop structure, wherein a plurality of sliding doors are supported in a first direction on a slide groove of a door frame so as to be slidably opened and closed and have a plurality of rollers installed in upper and lower portions in a second direction, perpendicular to the first direction, a gasket is installed on one surface of each sliding door in a third direction, perpendicular to the first and second directions, and is in close contact with an adjacent sliding door to prevent leakage of internal cold air, a rail formed to be inclined to one side is installed on at least one of upper or lower slide groove of the door frame, the rail being installed so that one of rollers is positioned on the rail when the sliding door is closed, and although gaskets are caught with each other when the adjacent sliding door is opened, the sliding door having the roller positioned on the rail is prevented from being opened by elasticity of the rail.

At least one of the upper or lower slide groove of the door frame may be provided with a stopper stopping movement of the sliding door, and the rail may be in close contact with one end of the stopper and a portion of the rail facing the stopper may be in close contact with the slide groove.

The plurality of sliding doors may include first to third sliding doors, the door frame may include an inner first slide groove in which the first and third sliding doors on both sides are installed and an outer second slide groove in which the second sliding door in the middle is installed, and a rail may be installed in the second slide groove.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of a showcase according to an embodiment of the present disclosure;

FIG. 2 is a cross-sectional view of FIG. 1;

FIG. 3 is an enlarged view of portion A of FIG. 2; and

FIG. 4 is a perspective view illustrating a rail and a stopper for explaining a stopping structure of a sliding door in a showcase according to an embodiment of the present disclosure.

### DETAILED DESCRIPTION

Hereinafter, embodiments of the present disclosure will be described with reference to the accompanying drawings. However, the embodiments of the present disclosure may be modified in various other forms, and the scope of the present disclosure is not limited to the embodiments described below.

In addition, the embodiments of the present disclosure are provided to more completely describe the present disclosure to those skilled in the art. The shapes and sizes of elements in the drawings may be exaggerated for a clearer description.

In the following description of the present disclosure, a detailed description of known functions and configurations incorporated herein will be omitted when it would make the subject matter of the present disclosure unclear. The terms used in the present specification are defined in consideration of functions used in the present disclosure, and may be changed according to the intent or conventionally used methods of clients, operators, and users. Definitions of the terms should be understood on the basis of the entire description of the present specification. Terms used in the following description are merely provided to describe embodiments of the present disclosure and are not intended to be limiting of the inventive concept. As used herein, the singular forms “a,” “an” and “the” are intended to include the plural forms as well, unless the context clearly indicates otherwise.

It will be further understood that the terms “comprises” or “has” when used in this specification, specify the presence of stated features, integers, steps, operations, elements, or a portion or combination thereof, but do not preclude the presence or addition of one or more other features, integers, steps, operations, elements, or a portion or combination thereof.

In this specification, terms, such as ‘top,’ ‘upper portion, ‘upper surface,’ ‘bottom,’ ‘lower portion, ‘lower surface, and ‘side surface’ are based on the drawings and may actually vary depending on the direction in which elements or components are arranged.

It will be understood that when an element is referred to as being “connected to” another element, it may be directly connected to the other element or intervening elements may also be present. In contrast, when an element is referred to as being “directly connected to” another element, no intervening elements are present.

Hereinafter, the present disclosure will be described in detail through each embodiment or example of the present disclosure. It should be noted that each embodiment or example described in this specification is not limited to only an embodiment or example and combinations with other embodiments or examples are also possible.

Therefore, the citation of claims in claims is only an example of an embodiment, and the technical idea of the present disclosure should not be interpreted only as a combination with the cited claims, and combinations with various claims are also included in the scope of the technical idea of the present disclosure.

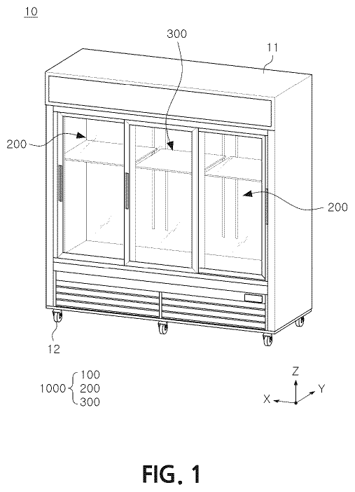

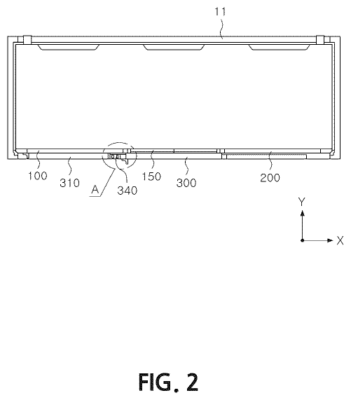

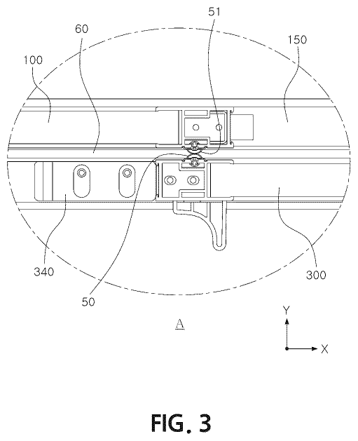

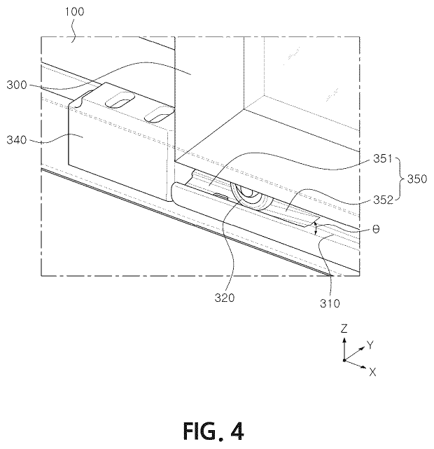

FIG. 1 is a perspective view of a showcase according to an embodiment of the present disclosure, FIG. 2 is a cross-sectional view of FIG. 1, FIG. 3 is an enlarged view of portion A of FIG. 2, and FIG. 4 is a perspective view illustrating a rail and a stopper for explaining a stopping structure of a sliding door in a showcase according to an embodiment of the present disclosure.

In the drawings, X is defined as a first direction in a length direction of the showcase 10, Y is defined as a third direction in a width direction of the showcase 10, and Z is defined as a vertical direction and a second direction in a height direction of the showcase 10.

Referring to FIGS. 1 to 4, a showcase 10 according to the present disclosure includes a plurality of sliding doors 1000 supported in a sliding groove of a door frame 11 so as to be slidably moved in the first direction X and opened and closed and having a plurality of rollers installed in upper and lower portions in the second direction Z, perpendicular to the first direction X.

The slide groove may be a slit-shaped groove formed on upper and lower inner surfaces of the door frame 11 or may be configured by coupling a separate groove member to the upper and lower portions of the door frame 11.

In addition, the interior of the door frame 11 may be configured in the form of a shelf divided into a plurality of storage spaces for displaying products, and a plurality of wheels 12 may be installed at the bottom of the door frame 11 to facilitate movement of the showcase 10.

Hereinafter, the present disclosure will be described more specifically by way of embodiments. It should be noted, however, that the following embodiments are intended to illustrate and specify the present disclosure and do not to limit the scope of the present disclosure. The scope of the present disclosure is determined by the matters described in the claims and the matters reasonably inferred therefrom.

The showcase 10 of an embodiment includes the first to third sliding doors 100, 300, and 200 arranged in order from left to right in the first direction X.

Here, the first sliding door 100 has a structure opened from left to right, the second sliding door 300 has a structure opened from left to right, and the third sliding door 200 has a structure opened from right to left.

The door frame 11 includes an inner first slide groove 150 in which the first and third sliding doors 100 and 200 on both sides are installed in the first direction X and an outer second slide groove 310 in which the second sliding door 300 in the middle is installed, and in an embodiment, a rail 350 is installed in the second slide groove 310 in which the second sliding door 300 located in the middle moves.

In addition, a gap 60 of a predetermined interval is provided between the first slide groove 15 and the second slide groove 310, and first and second gaskets 51 and 50 described below are positioned in the gap 60.

In the showcase 10 of an embodiment, the first and second gaskets 51 and 50 are installed on one surfaces facing each other at the ends of the first and second sliding doors 100 and 300 that overlap each other in the third direction Y, perpendicular to the first and second directions X and Z, when all the sliding doors are closed, and are in close contact with the adjacent second and first sliding doors 300 and 100 to prevent leakage of internal cold air.

Here, although not shown, gaskets are installed to be in close contact with each other in a similar manner to FIG. 3 on the right end of the second sliding door 300 and the left end of the third sliding door 200.

In the present disclosure, the rail 350 formed to be inclined to one side is installed on at least one of the upper or lower slide grooves of the door frame 11. However, in an embodiment, although the rail is described as being installed on the second slide groove 310 located in an outer lower portion, the rail may also be installed on the second slide groove 310 located in an upper portion, and may be installed on both the upper and lower second slide grooves if necessary.

In a case in which the rail is installed on the upper second slide groove, the rail is symmetrical in the second direction Z with the rail installed on the lower second slide groove, and thus, in order to avoid redundancy, the rail 350 installed on the lower second slide groove 310 will be described below with reference to the drawings, which is considered to include a structure in which the rail is installed on the upper slide groove.

At this time, the rail 350 is installed so that one of rollers 320 is positioned on the rail 350 when the second sliding door 300 is closed. The rail 350 is in a state in which one fixing portion 351 is tightly coupled to the second slide groove 310 by a bolt or the like in the first direction X, and an inclined portion 352 on the opposite side is lifted upward from a surface of the second slide groove 310 by a predetermined angle θ.

In the showcase 10 of the present disclosure, the first and second gaskets 51 and 50 are installed on one surfaces facing each other at the ends of the first and second sliding doors 100 and 300 that overlap each other in the third direction Y, perpendicular to the first and second directions X and Z, when all the sliding doors 1000 are closed, are in close contact with the adjacent second and first sliding doors 300 and 100 to prevent leakage of internal cold air.

Therefore, when the first sliding door 100 is opened, the first gasket 51 pushes the second gasket 50 of the second sliding door 300, so that the second sliding door 300 may be opened along with the first sliding door 100.

However, in an embodiment, the rail 350 acts as a catch by elasticity of the inclined portion 352 of the rail 350 to suppress the roller 320 from moving to the right, thereby preventing the second sliding door 300 from being unexpectedly opened along the first sliding door 100.

Meanwhile, a stopper 340 stopping the movement of the second sliding door 300 is installed in the second slide groove 310 of the door frame 11.

In an embodiment, since the second sliding door 300 is designed to be opened only to the right of the showcase 10, the stopper 340 may be fixedly installed at a point at which a right end of the first sliding door 100 and a left end of the second sliding door 300 meet, thereby preventing the second sliding door 300 from moving to the left.

At this time, if necessary, the stopper 340 may be installed in the upper second slide groove of the door frame 11 instead of the lower second slide groove 310 of the door frame 11, and it is also possible to install both in the second slide groove 310 formed in the upper and lower portions of the door frame 11.

In addition, the rail 350 may be installed in close contact with one end of the stopper 340, and a portion of the rail 350 facing the stopper 340 may be the fixing portion 351 closely fixed to the second sliding groove 310. Accordingly, the rail may be configured in a form inclined upward toward the right with respect to the stopper 340.

If the stopper 340 is installed in the upper second slide groove of the door frame 11, the rail 350 is inclined downward toward the right with respect to the stopper 340.

According to an embodiment of the present disclosure, the showcase having a sliding door with a stop structure, capable of preventing another sliding door from being opened unexpectedly along an adjacent sliding door may be provided.

While example embodiments have been shown and described above, it will be apparent to those skilled in the art that modifications and variations could be made without departing from the scope of the present disclosure as defined by the appended claims.

What is claimed is:

1. A refrigerating showcase having a sliding door with a stop structure, wherein:
a plurality of sliding doors are supported in a first direction on a slide groove of a door frame so as to be slidably opened and closed and have a plurality of rollers installed in upper and lower portions in a second direction, perpendicular to the first direction,
a gasket is installed on one surface of each sliding door in a third direction, perpendicular to the first and second directions, and is in close contact with an adjacent sliding door to prevent leakage of internal cold air,
a rail formed to be inclined to one side is installed on at least one of upper or lower slide groove of the door frame, the rail being installed so that one of rollers is positioned on the rail when the sliding door is closed, and
although gaskets are caught with each other when the adjacent sliding door is opened, the sliding door having the roller positioned on the rail is prevented from being opened by elasticity of the rail.

2. The refrigerating showcase of claim 1, wherein at least one of the upper or lower slide groove of the door frame is provided with a stopper stopping movement of the sliding door, and the rail is in close contact with one end of the stopper and a portion of the rail facing the stopper is in close contact with the slide groove.

3. The refrigerating showcase of claim 1, wherein
the plurality of sliding doors include first to third sliding doors,
the door frame includes an inner first slide groove in which the first and third sliding doors on both sides are installed and an outer second slide groove in which the second sliding door in the middle is installed, and
a rail is installed in the second slide groove.
